(19) United States
(12) Patent Application Publication
(10) Pub. No.: US 2007/0009680 A1
(43) Pub. Date: Jan. 11, 2007

(54) Synthetic turf system and method

(76) Inventor: Ted Dipple, Andover, MA (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/513,784

(22) Filed: Aug. 31, 2006

Related U.S. Application Data
(63) Continuation of application No. 10/994,568, filed on Nov. 22, 2004.
Application No. 10/994,568 is a continuation-in-part of application No. 10/931,125, filed on Aug. 31, 2004.

(51) Int. Cl. A41G 1/00; A01N 3/00

(52) U.S. Cl. 428/17

(57) ABSTRACT

This invention relates to a synthetic turf comprised of a backing, a synthetic grass-like surface which is comprised of textured and non-textured grass-like fibers that are secured to the backing. The synthetic turf is variable according to weight, composition and/or configuration to provide flexibility according to the needs of the particular application

### CROSS REFERENCE TO RELATED APPLICATIONS

The present application is a continuation of U.S. Ser. No. 10/994,568, filed Nov. 22, 2004, which is a continuation-in-part of U.S. Ser. No. 10/931,125, filed Aug. 31, 2004, the entire disclosure of which is incorporated by reference herein.

### FIELD OF THE INVENTION

This invention relates to an improved synthetic surface. More particularly, the invention relates to an improved synthetic surface system that includes all of the requisite elements for installing a synthetic playing surface.

### BACKGROUND OF THE INVENTION

For years natural turf surfaces were used for most outdoor sports: for example, soccer, football, field hockey, cricket, rugby, etc. Natural turf surfaces are surfaces constructed with a grass grown in soil, or some other surface layer of growth medium (e.g., sand and organic mixes, etc.), that is constructed upon a suitable foundation. A natural turf surface is generally preferred for its comfort, feel, grip, and appearance.

However, under heavy use and/or poor weather conditions, natural turf surfaces deteriorate rapidly and maintenance is costly. Intense activity on the turf destroys the grass and its root system, leaving mud and/or dirt on the playing surface. Prior to re-establishment of the turf, the surface is unsightly and often pockmarked, uneven, and possibly hazardous to use. Another problem associated with natural turf surfaces is the use of painted-on yardage and boundary lines. Typically, such boundary lines are formed by painting the playing surface. For aesthetic reasons, such lines are generally painted just prior to each official game played on the playing surface. The repeated application of paint to the surface of the playing surface tends to kill the grass that is located under the painted surface. In addition, over time the multiple layers of paint build up, forming a surface that is substantially harder than the surrounding natural grass playing surface.

Due to the needs of sports programs, even after destruction of portions of the turf, play usually continues on the playing surface, even when the surface is badly damaged, until the sport's season is over, when the turf can be re-established. Thus, the playing conditions on the playing surface continually decline over the season. At the end of the season, the natural turf surfaces are reseeded, the divots leveled and filled, etc. The natural turf surfaces are not usable during this re-establishment period. The re-establishment period typically takes at least four months, or longer, under ideal weather conditions, during which the natural turf surface should not be used.

Synthetic surfaces provide an alternative to natural turf surfaces. Synthetic surfaces generally come in three types, i.e., conventional, cryogenic rubber filled, and sand-filled or a combination of sand and cryogenic rubber. Conventional synthetic surfaces are a dense synthetic material that has the appearance of grass blades. Sand-filled and cryogenic rubber filled synthetic are synthetic materials that are similar to conventional synthetic turf, but with greater spacing between the blades, to accommodate a sand and/or cryogenic rubber filling.

Synthetic turf is installed with a carpet-like pile fabric having a flexible backing laid on a well drained compacted substrate, such as crushed stone or other stabilized base material. The pile fabric has rows of upstanding synthetic ribbons representing grass blades extending upwardly from the top surface of the backing.

Synthetic grass infill, for example, may comprise a mixture of 60% by weight of sand and 40% granulated cryogenic rubber particles uniformly mixed and deposited between the upstanding synthetic grass ribbons to a depth of 1 to 3 inches.

A high percentage of sand is preferred to minimize the cost of such systems, since cryogenic rubber particles are relatively expensive compared to sand. The sand particles also provide an improved degree of drainage that is needed where the synthetic grass surface is not in an enclosed stadium for example. Cryogenic rubber particles tend to impede the free flow of water, whereas the capillary action of the sand particles draws surface moisture downwardly due to the differences in surface tension characteristics between cryogenic rubber and silica sand.

Both the conventional and sand-filled synthetics are placed indoors or outdoors, upon a foundation that may include asphalt, concrete, wood, or other supporting subsurface along with cushioning mats, water drainage, and water irrigation. Although synthetic turf surfaces are more durable than well-established natural turf surfaces, they are only moderately successful for sports and other uses. The most notable disadvantages of synthetic turf surfaces are the discomfort for the players and an increased number of injuries. Yet, another concern with current synthetic grass systems is that there is a tendency of the filling (sand or cryogenic rubber) to compact over time. Thus, these surfaces are not satisfactory for many sports because the compaction of the top dressing limits the shock absorbing ability of the surface, and because “fill” top dressing is abrasive. Further, compacting of the fill eventually blocks the drainage holes of a synthetic turf system, thereby inhibiting proper drainage of moisture.

As can be seen from the above discussion, there exists a need for an improved surface for sports and other uses, and a method of making the improved surface, wherein the surface provides improved comfort and fewer injuries to the users, while being durable under heavy use and in poor weather conditions. The present invention is directed to fulfilling this need.

### SUMMARY OF THE INVENTION

One aspect provides for a synthetic turf comprised of a backing and a synthetic grass like surface. The synthetic grass-like surface, in one embodiment, can be comprised of textured and non-textured grass-like fibers, wherein the synthetic turf is variable according to weight, composition and/or configuration.

### BRIEF DESCRIPTION OF THE FIGURES

FIG. 1 shows a cross-sectional view of an exemplary synthetic turf system.

FIG. 2 shows a cross-sectional view of an exemplary synthetic turf system optionally connected to a vacuum system.

### DETAILED DESCRIPTION

In accordance with an embodiment of the present invention, a synthetic turf incorporates individual synthetic blades of grass like fibers, tufted into a dimensionally stable backing system with polyurethane pre-coat that facilitates tuft-bind. In one aspect, the backing system is comprised of two separate backings, a primary backing and a secondary backing. The primary backing can have from 10-20 weaves/inch (Pic). The secondary backing can have from 8-17 weaves/inch (Pic). The secondary backing comprises impermeable, inert urethane compound that is applied to the underside of the primary backing. The primary backing weight can range from about 3 to 15 oz/Square yard. The secondary backing weight can range from about 5 to about 30 oz/Square yard. By underside it should be understood to mean the side of the primary backing that is closest to the core surface (e.g. the cement, compacted stone, asphalt etc.)

The synthetic grass of the present embodiment may be tufted into one or both of the backings to provide additional support for the individual synthetic grass blades. In one aspect, the tuft bind is 21-pounds/Square inch. In other words, 21 pounds of force must be applied to a square inch of synthetic grass surface in order to remove the tufted grass from the backing system. The synthetic grass is then filled with a dressing layer comprised of cuboidal ambient rubber infill. Generally, the infill measures from 0.5 to 1.5 mm in diameter. The texturized fiber of the synthetic grass curls down to cover and trap the ambient rubber granules helping to prevent the system from expelling the infill upon impact from such sources as players feet or balls.

The length of the synthetic turf yarn may be selected to be an appropriate value, from 0.5 to 4 inches, depending on applications. In one aspect, the synthetic turf yarn is about 2^{1/4} inches. In one particular aspect, the synthetic turf has two face yarns, one of which is non-textured, and one of which is textured. Such textured yarns include melamin/phenol/formaldehyde molding compounds (MPF), a low density, rigid polyurethane textured material, which provides a curled yarn that helps provide a grip for the surface. One exemplary non-textured pile yarn is a Teflon coated (TtC) polyethylene. The synthetic turf may be preferably knitted, and the non-textured face yarn or pile has a pile height exceeding about 0.5 inch, preferably having a height of at least about 1.0 inch. In use, the textured pile has a height significantly lower than the pile height of the non-textured pile, preferably a pile height of at least 25% less than the pile height of the non-textured pile. The textured and non-textured pile yarns may be knotted together with a stitch-in yarn, to form rows of knots in the machine direction of the synthetic turf as it is being manufactured, and lay-in yarns are interlocked with the rows of knots to form a base for the pile yarns. A seal may be applied to the backing for additional dimensional stability. In yet another aspect, the tufting gauge, which is the distance between stitch rows, is between about ¼ inch to about ¾ inch. In one particular aspect, the tufting gauge is about ½ inch.

The pile weight describes the amount of fiber weight per square yard. In general, the higher the pile weight, the more fibers that result, and the more fiber, the better the quality of the system. In use, denser fibers fold over the ambient rubber granules to retain the rubber granules in place and prevent them from migrating over the field. Thus, in one aspect, the pile weight is at least 50 oz/Square yard, and more preferably, at least 55 oz/Square yard.

In another aspect, the synthetic turf according to an embodiment of the present invention is made using a knitting process. The synthetic turf is preferably mounted on a subsurface, and preferably the subsurface includes one or more of concrete or asphalt pavement, compacted clay, gravel, and gravel mixed with soil, and then more soil or a foamed product may be laid on the subsurface. A fill material, preferably particles comprised substantially of ambient rubber, is placed in and around the textured and non-textured pile, preferably to about the height of the textured pile. Any other types of fill may be utilized as well, such as other types of rubber and/or sand, as examples.

The synthetic grass in accordance with an embodiment of the invention is maintenance-free, provides a uniform surface, and has substantial give underfoot. Further, the synthetic grass in accordance with embodiments of the invention can be used in all weather conditions. The synthetic grass is preferably UV stabilized and can be installed overtop of a variety of surfaces including, asphalt, concrete, or compacted stone. In one preferred aspect, the turf is installed overtop layers of compressed stone of different sizes, wherein a drainage system is installed underneath of the compressed stone. In one aspect, the backing of the synthetic turf is secured by an adhesive, preferably glue, to the compressed stone.

Denier is defined as the number of grams in a 9,000 meter yarn strand. Essentially denier tells one how much material goes into the manufacture of a strand of fiber or one blade. The higher the denier the more dense the fibers. More density means better quality and longevity. The thickness and denier number of the synthetic grass filament used may be appropriately selected within a range suitable for a given application of the synthetic turf. However, when the synthetic turf yarn is too thin, it lacks durability, and when too thick, it differs from natural grass in appearance and feel. Therefore, in one embodiment, the synthetic turf yarn is preferably in the range of 5 to 15,000 denier. In one aspect, the denier is at least 10,000 denier.

In another aspect, the synthetic turf system includes drainage holes in the primary and secondary backing. These drainage holes can be scattered throughout the primary and secondary backing system. In one preferred aspect, the drainage holes allow the passage of moisture and other sediments to pass through the synthetic turf and backing system and into the compressed surface underneath. In one aspect, the drainage holes provide perforations, which are about 1 inch to about 3 inches in diameter. In one particularly preferred aspect, the drainage holes are between 2 and 2⅛ inches. The moisture then passes through the compressed surface and into the drainage system, so as to remove the moisture from the playing area.

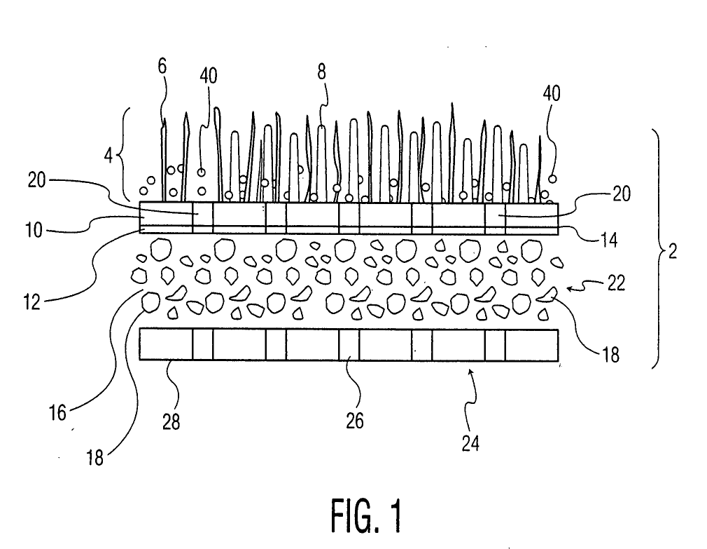

FIG. 1. shows a cross-sectional view of an exemplary synthetic turf system (2) for use as a playing surface. In particular, it shows a synthetic turf (4) that is comprised of non-textured synthetic fibers (6) and textured synthetic fibers (8) that are woven into a primary backing (10), which is in contact with a secondary backing (12). The textured and non-textured synthetic fibers behave as if they were individual blades of grass. The secondary backing has an adhesive, preferably, a polyurethane glue (14) on its underside, that facilitates the binding of the synthetic turf (4) to a surface, preferably comprised of compressed stone (16). In this embodiment, the surface is formed by multiple layers of compressed stone of differing sizes (18). Furthermore the primary backing (10) and secondary backing (12) have apertures (20) through which moisture can pass to the compressed stone (16). The apertures (20) are generally annular in configuration and are spread throughout the primary backing (10) and secondary backing (12). Of course, there can be any of a number of apertures (20), and the size, shape and location can vary depending on the individual conditions for each installment of the synthetic turf system.

The compressed stone in this embodiment (16) is in layers (22) that help to facilitate the flow of moisture from the synthetic turf (4) to a drainage system (24). The drainage system in this embodiment is comprised of one or more, and preferably an arrangement of drain pipes (28) that receive moisture passing through the apertures in the turf and the compressed stone. The pipes include at least one, and preferably, a plurality of apertures through its outer surface into which the moisture passing through the turf and compresses stone is received. The pipes carry the moisture to a designated location to dispose of the liquid, such as a public sewer. In other embodiments, other suitable types of drainage systems may also be used.

Further, the synthetic turf has a fill, preferably ambient rubber particles (40), displaced generally evenly between the fibers (8 and 6). This can be accomplished, for example, by using a conventional seed spreader to lay the ambient rubber particles, and then raked by hand or using a tractor to generally evenly displace the material. These ambient rubber particles (40) provide a cushion as well as a “natural like” feel and appearance.

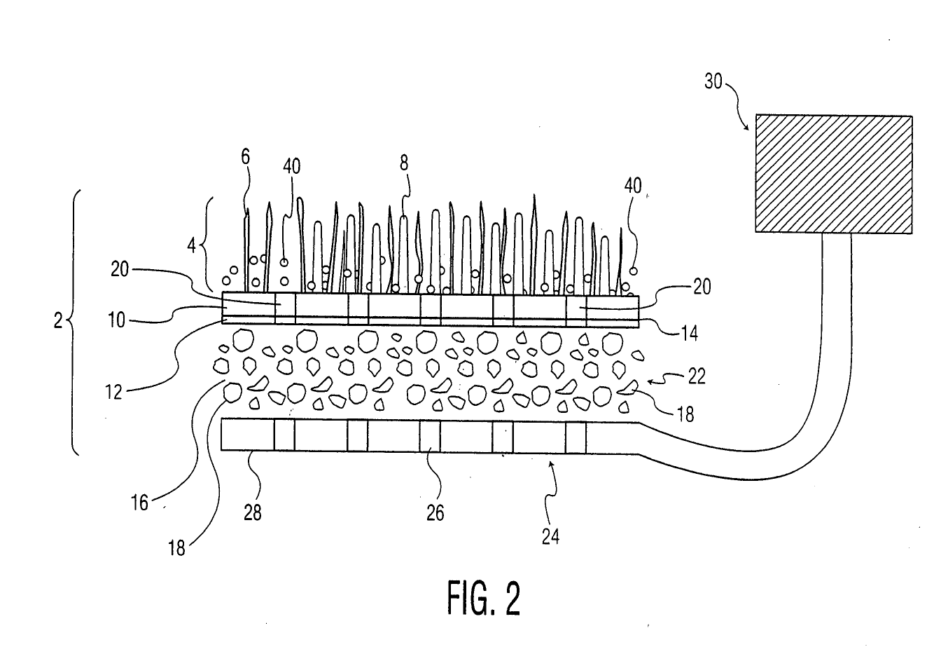

FIG. 2 shows a suction system (30) that is optionally included as part of the drainage system (24) and applies a suction pressure through the apertures (26) in the drain pipe (28) to assist in pulling moisture from the synthetic turf (4) to the drain pipe (28).

For purposes of illustration, the following sets forth physical characteristics of the various components of an exemplary embodiment of a synthetic turf system. This example is for explanatory purposes only, and in no way limits the scope of this invention.

Physical Characteristics

| | |
|---|---|
| 1. Yarn | TtC Polyethylene/MPF Texturized |
| 2. Pile Weight | 55 oz/Sq. Yd. |
| 3. Primary Backing Weight | 8 oz./Sq. Yd. |
| 4. Secondary Backing Weight | 20 oz./Sq. Yd. |
| 5. Foam Backing Weight | N/A |
| 6. Total Weight | 83 oz./Sq. Yd. |
| 7. Yarn I Denier | 10000 Dtex PE (denier) |
| 8. Yarn II Denier | 6/7500 MPF Texturized |
| 9. Pile Height | 2¼″ or 57 mm +/− 2 mm |
| 10. Tufting Gauge | ½ |
| 11. Primary Backing 1 | 15 Pic Polyback (weaves/inch) |
| 12. Primary Backing 2 | 13 Pic Polyback (weaves/inch) |
| 13. Widths | 12′ or 15′ |
| 14. Perforation | 2″ × 2⅛″ |

The yarn is tufted through the primary and secondary backing system to provide a tuft bind of 21 lbs/Square inch. Of course, a foam backing can also be employed as desired.

The ambient rubber used for the infill is comprised of material having the following weight percentages:

| | Min | | Max | |
|---|---|---|---|---|
| Acetone Extract | 8.0 | wt % | 22.0 | wt % |
| Ash | 0.0 | wt % | 8.0 | wt % |
| Carbon Black | 26.0 | wt % | 38.0 | wt % |
| Natural Rubber | 10.0 | wt % | 35.0 | wt % |
| Rubber Hydrocarbon | 42.0 | wt % | 56.0 | wt % |
| Moisture | 0.0 | wt % | 1.0 | wt % |
| Free Fabric | 0.0 | wt % | .05 | wt % |

The ambient rubber is granular and cuboidal and has a diameter of 0.5 to 1.5 mm. The ambient rubber described above when used as infill provides superior shock absorption, facilitates clearance of moisture, and allows for superior grip. This ambient rubber may be spread by a seeding machine to evenly distribute the rubber throughout the synthetic turf. The ambient rubber particles rest in the bottom portion of the synthetic turf blades, but do not become compacted upon compression. This facilitates the passage of moisture, since the rubber particles do not block the drainage holes in the synthetic turf backing system.

The synthetic turf is installed overtop of compacted stone of varying diameters. Underneath of the compacted stone is a drainage system that facilitates removal of water from the playing surface. The drainage system comprises an arrangement of pipes to carry the water to a location to dispose of the water, such as into the public sewer system. The drainage system can optionally include a pressurization system, which facilitates the gravitational flow of moisture into the drainage system, by applying a suction pressure through the apertures of the drainage pipes within the drainage system.

As should be understood, the configuration, composition and/or total weight of the synthetic turf may be variable as desired, such as, for example, based on the particular characteristics desired of the turf and/or the particular application for which the synthetic turf is to be used. As to configuration, it may be desired in certain embodiments to regulate the length and/or width of the synthetic turf according to the dimensions of a particular installation site, so that the synthetic turf may be installed with a limited number seams. In general, a problem that can occur in a given installation site is that areas where there are seams can wear over time, resulting with seams becoming loose and potentially separating. Any worn seams can be problematic from the standpoint of creating a tripping hazard and potential injury, as well as adversely affecting “play”, for example, in a soccer application, a worn seam can affect the direction of a ball traveling over it.

In certain embodiments, a direct correlation can be made between configuration, composition and weight of the synthetic turf, which is described in more detail below.

Synthetic turf is ordinarily manufactured in strips and then transported in rolls by truck to an installation site. Shorter length strips are typically manufactured to avoid the weight of a roll becoming too heavy, which can create difficulties in transportation as well as installation, which requires technicians to unload the rolls from the truck, and unroll the synthetic turf to install it on site. For example, as described in the embodiment above in paragraph 26, the total weight of the synthetic turf is 83 oz./Sq. Yd. (comprised of the pile weight, in combination with the primary and secondary backing weights). The length of the strips manufactured for this particular synthetic turf is limited for practical reasons, so that the total weight of the roll is manageable from the standpoint of transportation and installation. In certain applications, however, longer length strips may still be desired. For example, as to a soccer application, the dimensions of a field are generally regulated by international rules, and may range from 50-100 yards in width and 100-150 yards in length. For instance, regulation fields at the college level are currently 70 yards wide by 115 yards long. At the international professional level, fields may range from 75-80 yards in width to as long as 125 yards in length. Typically, professional fields at the international level are 75 yards wide by 120 yards in length. In addition, other applications may involve two or more fields adjacent to one another, and the desire being to have a single strip long enough to cover each of the fields. As an example, there may be two fields, with one being a regulation college field 70 yards wide, the second being a practice field 50 yards wide, and an area 10 yards wide separating the two fields, resulting with a length strip of 130 yards needed to cover the entire area. As discussed above, use of a shorter yard length of synthetic turf for these applications would require one or more seams in order for the turf to extend the total width of the areas to be covered.

In accordance with various embodiments, the length of strips of synthetic turf that may be produced can be related to the total weight of the synthetic turf. For example, where longer length strips of synthetic turf may be desired for a particular application, the total weight of the synthetic turf may be reduced accordingly, to avoid a drastic increase in the overall weight of a given roll. For instance, in the embodiment discussed above, the weight of the synthetic turf may be reduced down from 83 oz./Sq. Yd as may be desired, in order to produce longer sized strips, which may then still be manageable to be transported in a roll and easier to install. The weight of the synthetic turf itself can be reduced by a variety of ways, such as by reducing the individual weights of any one or a combination of any two or all three of the pile, the primary backing and/or the secondary backing. As some examples, as discussed earlier in this application, it is described that the primary backing weight can range from about 3 to 15 oz/Square yard, the secondary backing weight can range from about 5 to about 30 oz/Square yard, and the pile weight is at least 50 oz/Square yard, and more preferably, at least 55 oz/Square yard. As should be understood, however, these are merely examples, and other values may also be utilized. For instance, the pile weight may be less than 55 oz/Square yard, such as between about 30 to about 40 oz/Square yard, the primary backing weight less than 8 oz/Square yard and/or the secondary backing weight less than 20 oz/Square yard. Of course, any other desired values may also be used. The pile weight may also be affected by the composition of the synthetic turf, for example, the density of the turf, the number of blades per square foot and the length of the blade (pile height), which is described in more detail below.

In some exemplary embodiments, the synthetic turf utilized for a particular application may be represented by the formula w+q/c, where w is the weight of the synthetic turf in oz./Sq. Yd, q is the quality of the composition of the turf represented by the density, the number of blades per square foot and length of pile and c is the configuration of the synthetic turf. The configuration c can further be represented by length l in yards multiplied by width r in yards. In general, an increase in the configuration c corresponds to a decrease in one or both of the weight w or quality q. The quality q can be decreased by reducing one or more of the density, the number of blades per square foot and length of pile. In certain embodiments, the increase/decrease of the various components may be proportional where desired.

In one embodiment, the total weight of the synthetic turf may be any number within a range between about 40 oz./Sq. Yd to about 80 oz./Sq. Yd, in order to accommodate longer length strips. For example, in relation to the soccer applications discussed above, it may be desired that a 70 yard wide field accommodate strips of synthetic turf 80 yards long, so that a 5 yard buffer may be provided on each side. Similarly, it may be desired that a field 75 yards wide accommodate strips of synthetic turf 85 yards in length, so that a 5 yard buffer is provided at each side. In another embodiment, the total weight of the synthetic turf may be any number within a range between about 55 oz./Sq. Yd to about 60 oz./Sq. Yd. In other embodiments, the synthetic turf can be of any desired weight that is less than 83 oz./Sq. Yd, so as to enable strips of various lengths to be produced according to the desired application. As should be understood, in still other embodiments, the synthetic turf can be of any desired weight, including weights less than, equal to or greater than 83 oz./Sq. Yd, and be utilized to produce strips of any desired length, as may be desired according to the needs of the particular application.

In other embodiments, the composition and/or weight of the synthetic turf can be varied according to the needs of a particular application. For example, with respect to composition, as discussed above, the density of the turf, number of blades per square foot and length of blade may be varied according to the requirements of the particular installation site. For example, it may be sufficient for a practice area to have lower density turf, a lower blade per square foot ratio and/or shorter blade length without compromising on the level of quality needed. In other applications, such as a regulation soccer field for a college or professional level, it may be desired to maintain the highest quality, so that higher density turf, higher blade per square foot ratio and/or longer length blades would be utilized. The composition of the turf may also be modified by altering other elements as well, such as the type of yarn and processing, as examples. In addition, it may be desired in certain applications to have the turf manufactured in single length strips, however, with one or more portions of each strip containing turf of higher quality and one or more other portions of that strip containing turf of lower quality. This type of arrangement may be suitable, for example, in the situation where there are regulation and practice fields adjacent to one another.

The ability to vary composition results in the benefit that it can provide cost savings, since the appropriate level of quality for a given application can be purchased, rather than spending money for higher quality when it is not needed. In addition, as mentioned above, additional cost savings as well as easier transport and installation can be realized due to reduced weight associated with any reduction in the quality of the composition. Further, as to composition, another factor related to a reduction in quality is that the diameter of a roll is also decreased, since there is less volume to include in the roll, enabling more rolls to be transported on a truck, which can result in further cost savings, and easier handling for installation. As a result, the cost savings that can be realized due to a reduction in weight and/or composition of synthetic turf can offset any potential cost increases whenever longer length strips would be produced.

Overall, in view of that set forth above, it should be understood that the ability to vary composition (i.e. the density, blades per square foot and/or blade length of the pile), the weight of the overall turf (i.e., the pile and/or the backing), and the configuration of strips (i.e., the size), allows great flexibility to provide a customized product according to the needs of the particular application, including both equipment and personnel needs as to transportation and installation, as well as needs associated with how the installed system will be used.

The foregoing embodiments are especially suited for soccer, but can be utilized for any desired purpose, such as any sport activity, such as football, baseball, field hockey, as examples, or used just for landscape, such as at any commercial or residential location, a park or playground, to name a few.

The above description and the views and material depicted by the figures are for the purpose of illustration only and are not intended to be, and should not be construed as, limitations on the invention.

Moreover, certain modifications or alterations may suggest themselves to those skilled in the art upon reading of this specification, all of which are intended to be within the spirit and scope of the present invention as defined in the attached claims.

1. A method of customizing synthetic turf according to an intended application comprising:
(a) identifying an intended application;
(b) determining suitable parameters of weight, quality of composition, length and width of strips of synthetic turf based upon the intended application, wherein the synthetic turf is comprised of strips variable in construction according to weight, quality of composition, length and width, with increases in length or width of the strips corresponding to decreases in at least one of weight or quality of composition at least to a portion of the strips; and
(c) constructing the synthetic turf according to the determined parameters.

2. The method according to claim 1, wherein at least one of the weight or quality of composition is varied across a single piece of turf.

3. The method according to claim 1, wherein identifying the intended application comprises identifying the intended use from one or more uses selected from the group consisting of indoor fields, outdoor fields, football fields, soccer fields, lacrosse fields, cricket fields, rugby fields, baseball fields, softball fields, multipurpose fields and practice fields.

4. The method according to claim 1, wherein identifying the intended application comprises determining one or more limitations selected from the group consisting of an intended use of a surface that the turf is intended to cover, configuration of a surface that the turf is intended to cover, number of seams desired on the intended surface to be covered, delivery limitations and installation methods.

5. A method of customizing synthetic turf according to an intended application comprising:
(a) providing a synthetic turf in strips, each having a backing and a synthetic grass like surface comprised of grass-like fibers secured to the backing, wherein the strips are variable in construction according to weight, quality of composition and length, based upon the intended application for the synthetic turf, with increases in length of the strips corresponding to decreases in at least one of weight or quality of composition at least to a portion of the strips;
(b) identifying the intended application by determining one or more of the features selected from the group comprising: the intended use of a surface that the turf is intended to cover, configuration of a surface that the turf is intended to cover, number of seams desired on the intended surface to be covered, delivery limitations and installation methods;
(c) determining suitable parameters of weight, quality of composition and length of strips of synthetic turf based upon the intended application; and
(d) constructing the synthetic turf according to the determined suitable parameters by varying the weight, quality of composition and length of each strip of turf.

6. The method according to claim 1, wherein at least one of the weight or quality of composition is varied across a single piece of turf.

7. The method according to claim 5, wherein identifying the intended application comprises identifying the intended use from one or more uses selected from the group consisting of indoor fields, outdoor fields, football fields, soccer fields, lacrosse fields, cricket fields, rugby fields, baseball fields, softball fields, multipurpose fields and practice fields.
